(19) United States
(12) Patent Application Publication
(10) Pub. No.: US 2025/0162904 A1
(43) Pub. Date: May 22, 2025

(54) SYSTEMS AND METHODS FOR REMOVING SCALE ACCUMULATION AND PREVENTING SCALE FORMATION IN POOL AND SPA DEVICES

(71) Applicant: Pentair, Inc., Minneapolis, MN (US)

(72) Inventors: Sean McEwan, Chapel Hill, NC (US); Kenneth Koch, Apex, NC (US)

(21) Appl. No.: 18/954,092

(22) Filed: Nov. 20, 2024

Related U.S. Application Data
(60) Provisional application No. 63/601,133, filed on Nov. 20, 2023.

(51) Int. Cl. C02F 1/36; C02F 1/467; C02F 5/00; C02F 103/42

(52) U.S. Cl. CPC C02F 1/36; C02F 1/4674; C02F 5/00; C02F 2103/42; C02F 2303/22

(57) ABSTRACT

A pool or spa device is provided in the form of a housing, a first component, an ultrasonic device, and a controller. The housing defines an interior of the pool or spa device. The first component is positioned within the interior of the housing. The ultrasonic device is provided in the form of an ultrasonic generator and a first ultrasonic transducer. The ultrasonic generator is designed to generate at least one signal in an ultrasonic frequency range. The first ultrasonic transducer is in communication with the ultrasonic generator. In some instances, the first ultrasonic transducer is designed to produce ultrasonic vibrations in response to the at least one signal. The controller is in communication with the ultrasonic device. In some instances, the ultrasonic vibrations removes scale accumulation from the first component of the pool or spa device.

### CROSS-REFERENCE TO RELATED APPLICATIONS

This Application claims priority to U.S. Provisional Patent Application Ser. No. 63/601,133, filed on Nov. 20, 2023, entitled “A POOL/SPA DEVICE FOR REMOVING SCALE ACCUMULATION AND/OR PREVENTING SCALE FORMATION AND A METHOD THEREOF,” currently pending, the entire disclosure of which is incorporated herein by reference.

### TECHNICAL FIELD

The present invention relates generally to removing scale in a pool or spa device and more particularly to an ultrasonic device designed to remove scale accumulation and/or preventing scale formation in the swimming pool or spa device.

### BACKGROUND

Swimming pools and spas are commonly used in residences, hotels, and other locations and are commonly equipped with various swimming pool or spa devices. Examples of these swimming pool or spa devices include a salt chlorine generator, a gas-fired pool heater, or a pool water chemistry controller. One common issue with the use of the pool or spa devices is the formation, deposition, and/or accumulation of scale during their operation. Minerals such as calcium in the water of the pool or spa device can lead to scale formation. Calcium is typically present in balanced swimming pools or spas at a concentration of 200-400 ppm, while the concentration of carbonate ions in the water may at least partially depend on the water's pH level. The calcium in the water can combine with the carbonate ions to form calcium carbonate, which in turn precipitates in the swimming pool or spa device. The propensity of this phenomenon depends on a variety of factors including, but not limited to, water and surface temperatures, water movement (e.g., roughness, velocity), pH levels, and the solubility or saturation index associated with the pool or spa application. Most significantly, calcium carbonate scale formation occurs during elevated temperatures due to the lower solubility of calcium in conjunction with higher pH values resulting from the increased carbonate ion concentration.

Scale formation, including calcium carbonate scale, has many undesirable characteristics affecting the overall performance of the swimming pool or spa device, such as increased hydraulic resistance, decreased heat transfer, and diminished electrolytic activity. Currently, removing scale from these swimming pool or spa devices requires offline mechanical or chemical cleaning, which incurs costs for the device's owner and prevents the device's use.

Therefore, the art recognizes the need for a system and a method for removing scale accumulation and/or preventing scale formation in a swimming pool or spa device. The art also recognizes the need for a solution for automatically removing scale accumulation and/or automatically preventing scale formation in a swimming pool or spa device.

### SUMMARY

In some aspects, a pool or spa device is provided in the form of a housing, a first component, an ultrasonic device, and a controller. The housing defines an interior of the pool or spa device. The first component is positioned within the interior of the housing. The ultrasonic device is provided in the form of an ultrasonic generator and a first ultrasonic transducer. The ultrasonic generator is designed to generate at least one signal in an ultrasonic frequency range. The first ultrasonic transducer is in communication with the ultrasonic generator. The first ultrasonic transducer is designed to produce ultrasonic vibrations in response to the at least one signal. The controller is in communication with the ultrasonic device. The ultrasonic vibrations remove scale accumulation from the first component of the pool or spa device.

In some instances, the ultrasonic vibrations also prevent scale formation in the pool or spa device.

In some instances, the pool or spa device is a salt chlorine generator, a gas-fired heater, or a water chemistry management system.

In other instances, the pool or spa device is a salt chlorine generator, and the first ultrasonic transducer is positioned proximate to an electrode plate of the salt chlorine generator.

In some instances, the pool or spa device is a salt chlorine generator, and the ultrasonic device includes a second ultrasonic transducer. In this instance, each of the first ultrasonic transducer and the second ultrasonic transducer are positioned proximate to the electrode plate of the salt chlorine generator.

In other instances, the ultrasonic device includes a second ultrasonic transducer.

In some instances, the pool or spa device is provided in the form of a water chemistry management system and the first ultrasonic transducer is positioned adjacent to an injection port of the water chemistry management system.

In some instances, the pool or spa device is provided in the form of a water chemistry management system and the first ultrasonic transducer is coupled to a flow cell of the water chemistry management system.

In other instances, the first component is provided in the form of an electrode cell.

In other aspects, a pool or spa device is provided in the form of a body, an ultrasonic device, and a controller. The body is designed to retain one or more components of the pool or spa device. The ultrasonic device is provided in the form of an ultrasonic generator that is in communication with a first ultrasonic transducer. The controller is designed to activate the ultrasonic generator. The ultrasonic generator sends a signal to the first ultrasonic transducer during operation of the ultrasonic device.

In some instances, the ultrasonic device is designed to prevent scale accumulation in the pool or spa device.

In other instances, the pool or spa device is a salt chlorine generator, a gas-fired heater, or a water chemistry management system.

In some instances, the one or more components of the pool or spa device include a plurality of electrode plates.

In other instances, the pool or spa device is provided in the form of a salt chlorine generator including a plurality of electrode plates. In this instance, the first ultrasonic transducer is positioned proximate to a first side of the plurality of electrode plates, and a second ultrasonic transducer of the ultrasonic device is positioned on a second side of the plurality of electrode plates.

In some instances, the first ultrasonic transducer is positioned above or below a plurality of electrode plates of a salt chlorine generator.

In some instances, the ultrasonic generator is positioned outside of the body of the pool or spa device.

In some instances, the first ultrasonic transducer extends at least partially into the body of the pool or spa device.

In other instances, the ultrasonic generator and the first ultrasonic transducer are positioned within the body of the pool or spa device.

In other instances, the pool or spa device is provided in the form of a gas-fired heater, and the first ultrasonic transducer is positioned adjacent to a plurality of coils of a heat exchanger of the gas-fired heater.

In yet other aspects, a method for removing and preventing scale accumulation in a pool or spa device is provided. The method includes providing an ultrasonic device provided in the form of an ultrasonic generator and an ultrasonic transducer, generating an ultrasonic signal via the ultrasonic generator, receiving the ultrasonic signal from the ultrasonic generator, and producing vibrations in the ultrasonic transducer in response to the ultrasonic signal from the ultrasonic generator. The ultrasonic transducer is received in the pool or spa device.

In some instances, the method includes a step of removing the scale accumulation from the pool or spa device.

### BRIEF DESCRIPTION OF THE DRAWINGS

FIG. 1 is an isometric view of an example salt chlorine generator constructed according to the teachings herein;

FIG. 2 schematically illustrates a block diagram of a controller used in various pool and spa devices disclosed herein, including the salt chlorine generator of FIG. 1;

FIG. 3A is an isometric and partially cross-sectioned view of the salt chlorine generator of FIG. 1 including an example of an ultrasonic device;

FIG. 3B is an isometric and partially cross-sectioned view of the salt chlorine generator of FIG. 1 including another example of an ultrasonic device;

FIG. 3C is an isometric and partially cross-sectioned view of the salt chlorine generator of FIG. 1 including yet another example of an ultrasonic device;

FIG. 3D is an isometric and partially cross-sectioned view of the salt chlorine generator of FIG. 1 including another example of an ultrasonic device;

FIG. 3E is an isometric and partially cross-sectioned view of the salt chlorine generator of FIG. 1 including yet another example of an ultrasonic device;

FIG. 3F is an isometric and partially cross-sectioned view of the salt chlorine generator of FIG. 1 including another example of an ultrasonic device;

FIG. 3G is an isometric and partially cross-sectioned view of the salt chlorine generator of FIG. 1 including yet another example of an ultrasonic device;

FIG. 3H is an isometric and partially cross-sectioned view of the salt chlorine generator of FIG. 1 including another example of an ultrasonic device;

FIG. 4A is a cross-sectional view of a water chemistry management system including an ultrasonic device;

FIG. 4B is a cross-sectional view of a water chemistry management system for a swimming pool or spa including another example of an ultrasonic device;

FIG. 4C is a cross-sectional view of a water chemistry management system for a swimming pool or spa including yet another example of an ultrasonic device;

FIG. 4D is a cross-sectional view of a water chemistry management system for a swimming pool or spa including another example of an ultrasonic device;

FIG. 5A is an isometric view of a gas-fired pool heater for a swimming pool or spa, constructed according to the teachings herein;

FIG. 5B is an isometric view of the gas-fired pool heater of FIG. 5A with some portions of the gas-fired pool heater removed, the gas-fired pool heater including another example of an ultrasonic device;

FIG. 5C is an isometric view of the gas-fired pool heater of FIG. 5A with some portions of the gas-fired pool heater removed, the gas-fired pool heater including yet another example of an ultrasonic device;

FIG. 5D is an isometric view of the gas-fired pool heater of FIG. 5A with some portions of the gas-fired pool heater removed, the gas-fired pool heater including another example of an ultrasonic device;

FIG. 5E is an isometric view of heating coils of the gas-fired pool heater of FIG. 5A positioned proximate to yet another example ultrasonic device;

FIG. 6A schematically illustrates a set of connections between a swimming pool or spa device, an ultrasonic generator, and one or more ultrasonic transducers;

FIG. 6B schematically illustrates another set of connections between a swimming pool or spa device, an ultrasonic generator, and one or more ultrasonic transducers; and

FIG. 7 schematically illustrates a method for removing scale accumulation and/or preventing scale formation in a swimming pool or spa device according to the principles of this disclosure.

### DETAILED DESCRIPTION

Before any instances of the invention are explained in detail, it is to be understood that the invention is not limited in its application to the details of construction and the arrangement of components set forth in the following description or illustrated in the following drawings. The invention is capable of other instances and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use instances of the invention. Various modifications to the illustrated instances will be readily apparent to those skilled in the art, and the generic principles herein can be applied to other instances and applications without departing from instances of the invention. Thus, instances of the invention are not intended to be limited to instances shown but are to be accorded the widest scope consistent with the principles and features disclosed herein. The following detailed description is to be read with reference to the figures, in which like elements in different figures have like reference numerals. The figures, which are not necessarily to scale, depict selected instances and are not intended to limit the scope of instances of the invention. Skilled artisans will recognize the examples provided herein have many useful alternatives and fall within the scope of instances of the invention.

As further described herein, an ultrasonic device provided in the form of an ultrasonic generator and one or more ultrasonic transducers may be used for the prevention and/or removal of scale accumulation in a swimming pool or spa device. The ultrasonic device may be initiated on demand, manually implemented, and/or activated at predetermined time intervals (e.g., continuously, once a second, once a minute, once a day, once a week, once a month, etc.) to remove and/or help prevent scale accumulation. Further, it is to be understood that the ultrasonic transducers may be activated more than once. For example, an activation of the one or more ultrasonic transducers may be carried out at a first time period followed by a second activation at a second time period, in which the amount of time that elapses between the first time period and the second time period is determined by the predetermined time interval or another predetermined operational condition (e.g., after a predetermined amount of scale has accumulated within the swimming pool or spa device). In some instances, the amount of scale accumulation may be detected by a sensor associated with the pool or spa device.

The one or more ultrasonic transducers may be provided in the form of one or more direct ultrasonic transducers and/or one or more indirect ultrasonic transducers. The direct and indirect ultrasonic transducers may be structurally similar to each other. However, the direct and indirect ultrasonic transducers may remove and/or prevent scale formation differently. For example, the one or more direct ultrasonic transducers may be positioned on, near, and/or coupled to a component of the swimming pool or spa device where the scale may accumulate or form. In turn, the one or more direct ultrasonic transducers may apply ultrasonic energy to one or more components of the swimming pool or spa device where scale forms and/or accumulates, which may cause the one or more components to vibrate. In comparison, the one or more indirect ultrasonic transducers may be positioned proximate or adjacent to one or more components of the swimming pool or spa device where the scale may accumulate or form. The ultrasonic energy generated by the one or more indirect ultrasonic transducers may be applied to the water surrounding the one or more indirect ultrasonic transducers, forming waves in the water. The waves may in turn help remove and/or prevent the formation of scale on the swimming pool or spa device.

Moreover, the one or more ultrasonic transducers may apply varying frequencies and power levels to create acoustic microstreaming. The acoustic microstreaming may disrupt the solid-to-liquid boundary and help prevent the formation of the scale before scale accumulation can occur. In addition, the one or more ultrasonic transducers may cause cavitation in the water surrounding the one or more ultrasonic transducers, forming bubbles that release the ultrasonic energy and thereby removing the scale that has already formed on the surface of the swimming pool or spa device.

In some instances, the swimming pool or spa device may correspond to a swimming pool or spa salt chlorine generator, a swimming pool or spa heater (e.g., a gas-fired heater), or a swimming pool or spa water chemistry controller. Additionally, the device disclosed herein may be used with any other pool or spa device that accumulates scale.

In some instances, the scale may comprise a calcium-containing compound. For example, the scale may comprise calcium carbonate, calcium silicate, calcium sulfate, and/or calcium phosphate. In various instances, the scale may comprise calcium carbonate.

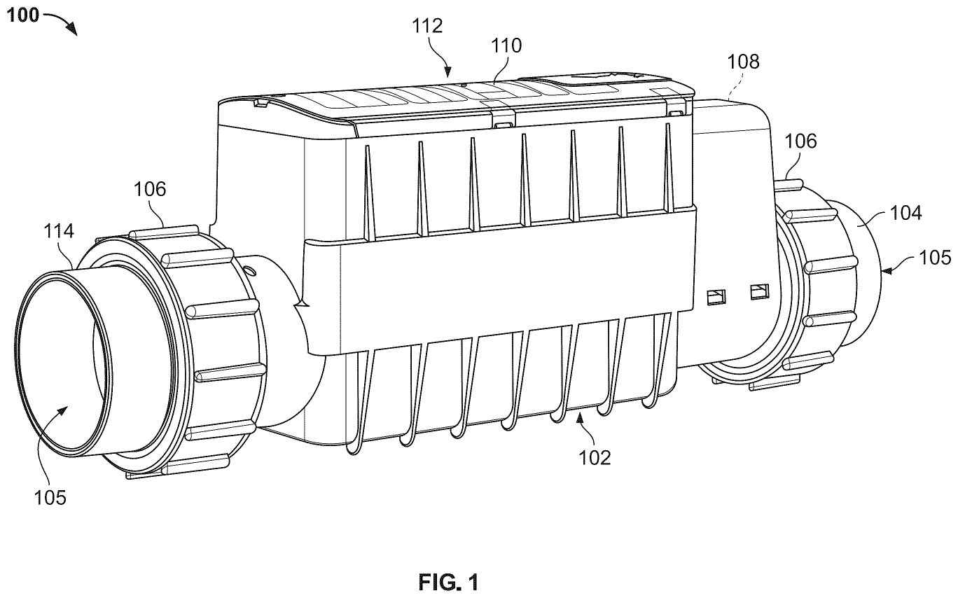

Referring now to FIG. 1, an example salt chlorine generator 100 (hereinafter referred to as a SCG 100) is shown. The SCG 100 may be used to generate and provide chlorine to a swimming pool or spa. The SCG 100 may include a body 102, an inlet 104, an O-ring coupling 106, an internal flow switch 108, one or more buttons 110, a control panel 112, and an outlet 114.

The body 102 of the SCG 100 may be provided substantially in the shape of a rectangular prism, although the body 102 may also be provided in other shapes and forms. The body 102 may be coupled to or integrally formed with the inlet 104.

The inlet 104 may be designed to provide fluid communication between a swimming pool or spa and the SCG 100. The inlet 104 may be a substantially hollow and cylindrical component that extends outwardly and away from the body 102, although the inlet 104 may also be provided in other shapes and forms. The inlet 104 may also include an aperture 105 that allows for water from the SCG 100 to enter the body 102 of the SCG 100.

The body 102 may also be coupled to or integrally formed with the outlet 114. The outlet 114 may be designed to communicate an output of the SCG 100 to the swimming pool or spa. As such, the outlet 114 may be in fluid communication with the swimming pool or spa. The outlet 114 may be a substantially hollow, cylindrical component that extends outwardly and away from the body 102, although the outlet 114 may be provided in other shapes in forms. Like the inlet 104, the outlet 114 may be provided with the aperture 105.

The O-ring 106 may be coupled to and positioned around the inlet 104 and the outlet 114 of the SCG 100. In some instances, the O-ring 106 may help create a fluid seal at the inlet 104 and outlet 114 of the SCG 100.

Referring still to FIG. 1, the internal flow switch 108 may be designed to detect a flow of water and/or a temperature of water flowing through the SCG 100. In some instances, the internal flow switch 108 monitors the flow of water through the SCG 100 and may act as a safety mechanism to prevent the generation of chlorine if such chlorine generation could damage the SCG 100. In some instances, the internal flow switch 108 may be designed to detect an amount scale accumulation in the SCG 100. For example, the internal flow switch 108 may detect changes in the flow rate of water (i.e., a flow rate reduction) through the SCG 100 associated with the formation of scale in the body 102. The internal flow switch 108 may be positioned in the body 102 of the SCG 100.

The one or more buttons 110 may control the amount of chlorine produced by the SCG 100. Generation of chlorine by the SCG 100 may be manually initiated by actuating the one or more buttons 110. In some instances, the one or more buttons 110 may display or include an “up” arrow button and/or a “down” arrow button. Actuating the “up” arrow button may increase the chlorine output level of the SCG 100. Actuating the “down” arrow button may decrease the chlorine output of the SCG 100. Actuating both the “up” and “down” arrow buttons at the same time may activate a “BOOST mode,” which may set the chlorine output of the SCG 100 to 100% for 24 hours. In some instances, actuating both the “up” and “down” arrow buttons while the “BOOST mode” is activated may cancel the “BOOST mode.” The one or more buttons 110 may be positioned on the exterior of the body 102 of the SCG 100.

In some instances, the one or more buttons 110 may be provided on the control panel 112. As stated previously, the one or more buttons 110 may be used to control the SCG 100 and to initiate chlorine production. In certain cases, the control panel 112 may include LED indicators designed to communicate information related to the operation of the SCG 100 to the user. In certain instances, the control panel 112 may be provided in the form of an LCD touchscreen. The SCG 100 may measure the water temperature and a salt level in the water in order to produce chlorine at the defined output indicated by a user when the user selects a desired button 110. In some instances, the SCG 100 may measure the water temperature using a thermistor (not shown) located within the internal flow switch 108. In some instances, the SCG 100 may measure the salt level by detecting the conductivity of the water through a conductivity sensor (not shown) integrated into the SCG 100. If the salt level is too low, the SCG 100 may be turned off until salt is added to the swimming pool or spa.

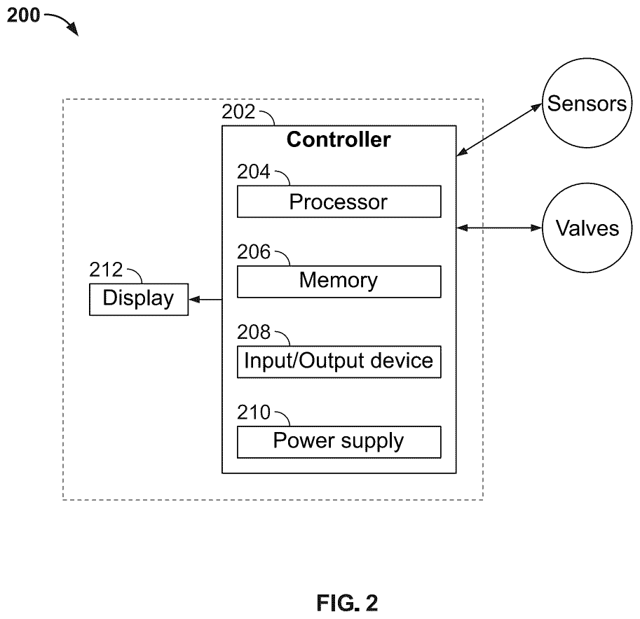

Referring now to FIG. 2, a control system 200 is provided in the form of a controller 202 and a display 212. The control system 200 may be used as a local controller of the SCG 100 of FIG. 1, the numerous examples of the ultrasonic devices discussed herein, along with any other pool or spa device discussed herein. In other instances, the control system 200 may be a central controller positioned locally or at a remote location, the central controller designed to control more than one pool or spa device, including the ultrasonic devices described herein. As shown in FIG. 2, the controller 202 may be in electronic communication with the display 212. The controller 202 may also be in electronic communication with one or more of the components of the SCG 100, including one or more sensors (e.g., the sensors of the internal flow switch 108) and one or more valves associated with either the SCG 100 or the swimming pool or spa. The controller 202 may be in electronic communication with the SCG 100 via one or more wires or may be electronically coupled to the SCG 100 via a communications network. The communications network may be a Local Area Network (LAN), a Wide Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information. In some instances, the display 212 may be an LED, LCD, or OLED display.

The controller 202 may be Bluetooth enabled and have Internet of Things (IoT) connectivity. The one or more components of the pool or spa (e.g., the sensors, the valves, a feeder, and/or a pump) may be IoT-enabled and/or communicatively connected smart components.

The controller 202 may send or receive electronic signals from one or more of the sensors of the pool or spa including pressure sensors, TDS sensors, temperature sensors, sensors adapted to detect scale accumulation, and/or any other sensors provided in a pool or spa system. The electronic signals received from one or more of the sensors may provide measurements and other data regarding pressure, flow rate, total dissolved solids, conductivity, pH level, scale accumulation, or the temperature of the water at various locations in the pool or spa system. The measurements and other data may be sent to the controller 202 by the one or more sensors continuously, frequently, or periodically.

The control system 200 may use the measurements or other data received from one or more of the sensors to send electronic signals to the valves, feeders, pumps, heaters and/or the other components of the pool or spa system. In some instances, the controller 202 may send an electronic signal to a valve to open or close, either partially or fully. The controller 202 may send an electronic signal to the SCG 100 to start, stop, increase, or decrease the amount of chlorine generated by the SCG 100. The controller 202 may determine to operate the ultrasonic device (e.g., an ultrasonic device 301) in response to one or more determined parameters associated with the operation of the SCG 100. The controller 202 may send an electronic signal to a pump to start, stop, increase, or decrease the speed of the pump. Adjusting one or more components of the pool or spa system (e.g., the valves, the feeder, the pump, the pool heater, the ultrasonic device, the SCG 100) may change the flow rate of the water into, through, or out of the system, the flow direction of the water within the system, the water temperature, the amount of chemical provided to the water, and/or the pressure of the water in various lines of the pool or spa system. The controller 202 may also receive electronic signals from the one or more components of the pool or spa system.

The controller 202 may include electronic components such as one or more processors 204, a memory 206 (e.g., random access memory (RAM)), an input/output device 208, and a power supply 210 (e.g., battery or AC adapter plug). The controller 202 may be able to download, store, and/or execute software having computer-executable instructions. The software may include one or more modules. The one or more modules may include, for example, algorithms to monitor and/or store the measurements or other data received from one or more of the system components such as the sensors, valves, feeders, or pumps, or may monitor and/or store real-time and historic flow patterns and usage data. The controller 202, via the one or more modules, may also perform calculations or other data analysis or modeling processes to determine various outcomes. The outcomes may include, for example, turning one or more of the system components of the SCG 100, the ultrasonic device, and/or any other swimming pool or spa device on or off at certain times or intervals and/or placing one or more of the system components in standby mode.

In some instances, the controller 202 may be able to self-diagnose or troubleshoot problems that arise without input from a user. Artificial intelligence (AI) or machine learning (ML) may be used to learn different patterns of usage to predict future behavior.

In some instances, the one or more modules may include a training module that may be designed to execute instructions related to one or more data analysis and modeling processes. In some instances, the training module may generate and iteratively train the machine learning training model to provide dynamic data analysis and outcomes, and the advanced analytics may be used to perform system and/or component diagnostics, generate alerts, notifications, or action items, provide customized recommendations according to user or service provider settings or preferences, and similar processes.

In some instances, one or more metrics or characteristics associated with the pool or spa (such as historic water usage data, historical usage data of the ultrasonic devices, system pressure, TDS concentration, or water flow rates) may be used as parameters in one or more processes to iteratively train a training model or a plurality of machine learning training models. One skilled in the art will understand that processes for “iteratively training the machine learning training model” may include machine learning processes, artificial intelligence processes, and other similar advanced machine learning processes. In various instances, the iteratively trained machine learning model(s) can be designed to perform various advanced data analysis and modeling processes. In some instances, these processes can be performed by multiple machine learning models, multiple aspects of a single machine learning model (e.g., an ensemble model), or a combination thereof. In one non-limiting embodiment, the machine learning training model(s) can be designed to generate, train, and execute a plurality of nodes, neural networks, gradient boosting algorithms, mutual information classifiers, random forest classifications, and other machine learning and artificial intelligence-related algorithms. A person skilled in the art will appreciate that the system and processes described can include additional or different details, data, measurements, parameters, metrics, and characteristics than those explicitly mentioned herein.

It is to be understood that one or more of the values associated with the methods and processes described herein (e.g., the amount of scale accumulation within the pool or spa device, an elapsed amount of time, etc.) may be measured and provided to the controller 202 at different time periods. The one or more values described with reference to methods and processes disclosed herein may be measured on demand, manually implemented, or at predetermined time intervals (e.g., continuously, once a second, once a minute, once a day, once a week, once a month, etc.). Further, it is to be understood that the one or more of the values associated with the methods and processes disclosed herein may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition. In each instance, such measurements may be carried out by one or more sensors associated with the pool or spa devices and then received and stored by a controller (e.g., the controller 202 of FIG. 2 and/or local controllers of the pool or spa devices).

In addition, the predetermined values, thresholds, ranges, and other information described with reference to the methods and processes disclosed herein may be manually implemented or otherwise input into the system. For example, the predetermined values and predetermined ranges may be manually input into a user interface of a controller (e.g., the controller 202 and/or local controllers of the pool or spa components), provided to the controller via a user device that is in communication with the controller or otherwise associated with and retained by the controller 202. For example, a predetermined value of scale accumulation associated with triggering activation of the ultrasonic device may be manually input into the controller by a user. As an additional example, a predetermined value for an amount of time that elapses between automatic activations of the ultrasonic device may be provided to the controller 202 from a remote server or user device.

In some instances, a lookup table of predetermined values, thresholds, ranges, and other information may be stored by a controller (e.g., the controller 202 and/or local controllers of the pool or spa components), and the controller may determine an appropriate action based on one or more of the variables discussed herein. In addition, the controller 202 may include pre-stored lookup tables. Furthermore, the controller 202 may be in communication with a network (e.g., a cloud network) and may be capable of downloading lookup tables. The controller 202 may select threshold values (e.g., a threshold amount of scale accumulation) from the lookup tables based on a number of factors including the pH, turbidity, free chlorine content, ORP value, calcium concentration and/or other parameters associated with the water of the pool or spa.

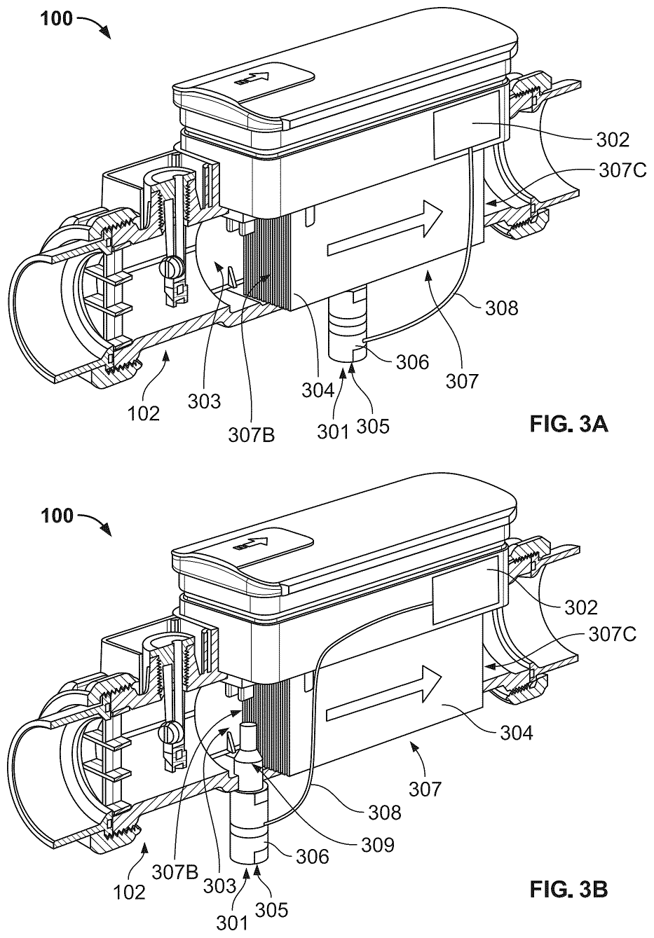

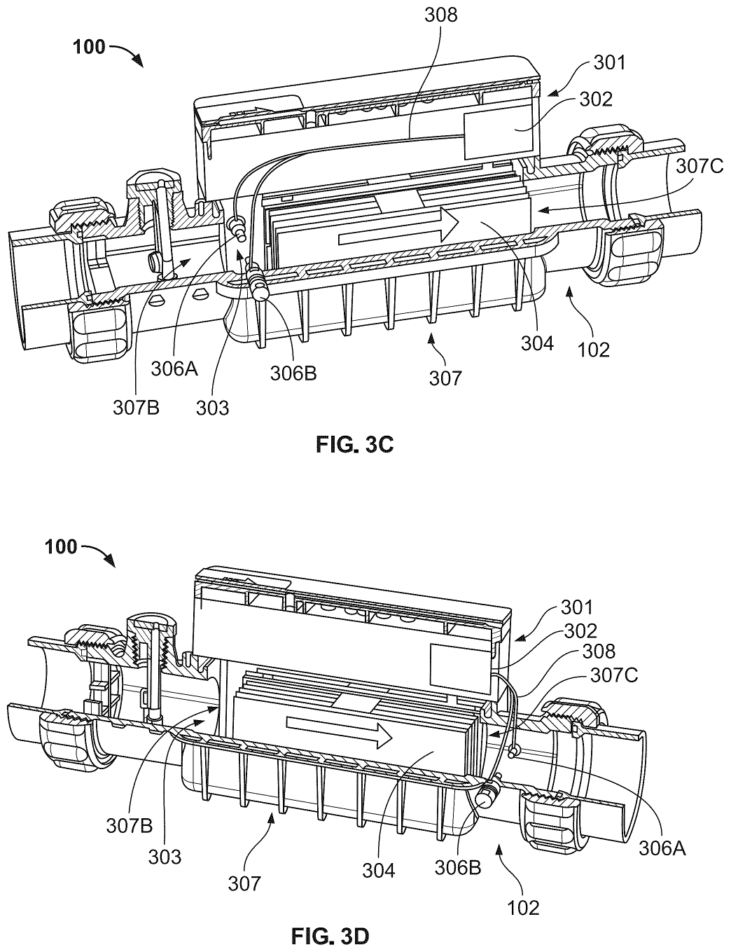

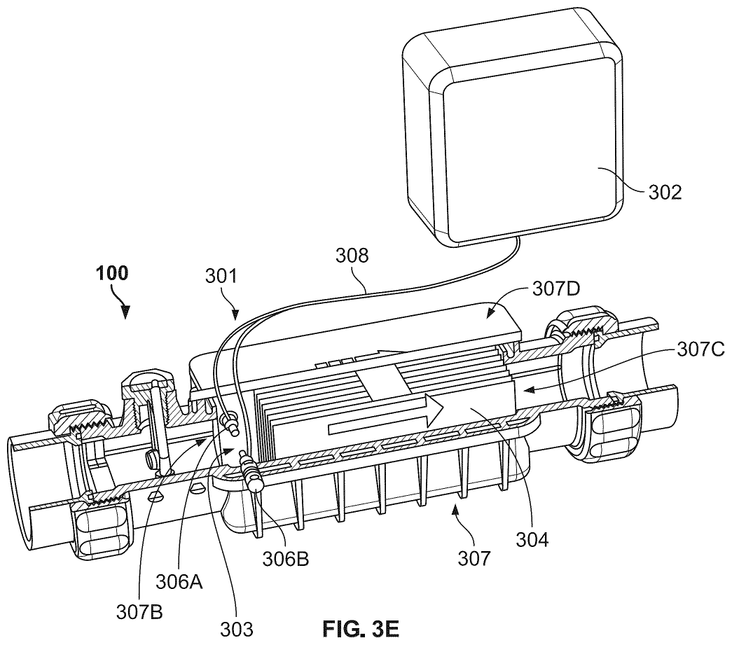

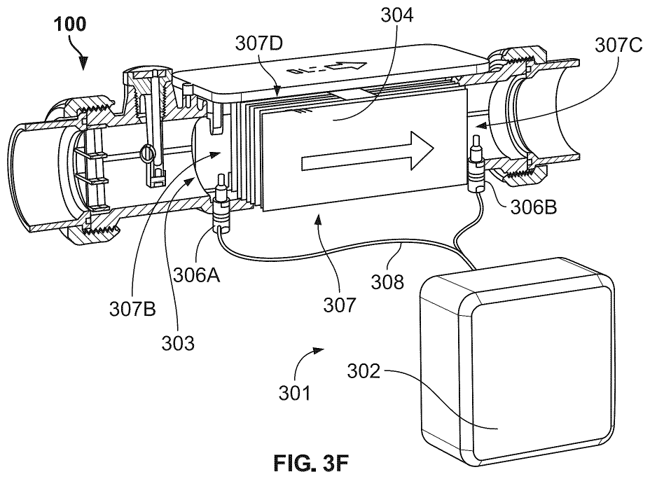

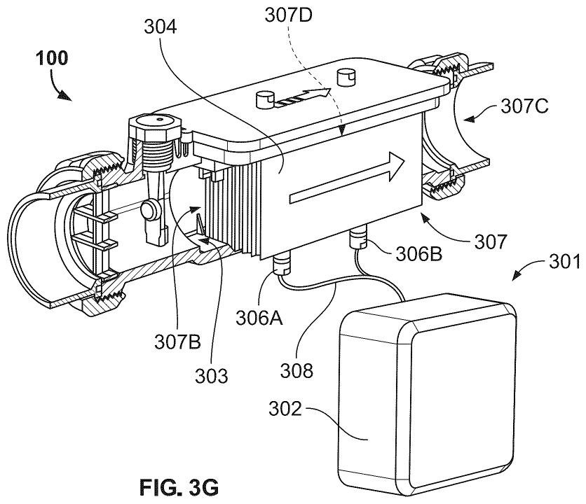

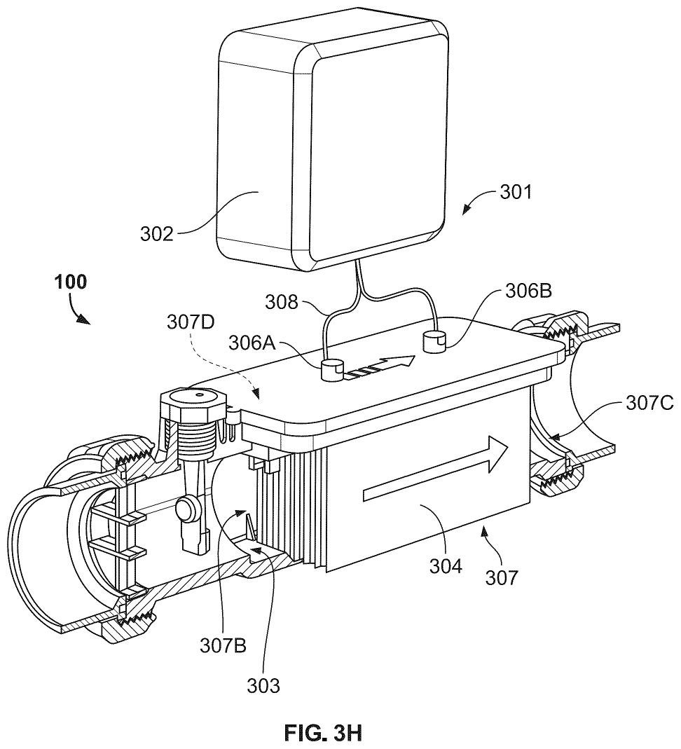

Together, FIGS. 3A-3H illustrate various implementations of an ultrasonic device, each implementation designed to remove and/or help prevent scale accumulation in the SCG 100. As will be further described herein, the ultrasonic device may be designed to provide ultrasonic energy to components of the SCG 100 that are likely to accumulate scale and/or to provide ultrasonic energy to the water surrounding such components. The application of this ultrasonic energy may remove and/or help prevent scale accumulation in the SCG 100. The various implementations may differ from each other based on the placement of the components (e.g., an ultrasonic generator, one or more ultrasonic transducers) of the ultrasonic device and, in turn, whether the ultrasonic device is primarily intended to provide the ultrasonic energy directly to the components of the SCG 100 (and thereby induce vibrations in the components) or the water surrounding the components of the SCG 100.

Referring first to FIG. 3A, the SCG 100 includes an ultrasonic device 301 provided in the form of an ultrasonic generator 302 and one or more ultrasonic transducers 306. The ultrasonic device 301 may be positioned in an interior 303 of the SCG 100. Water provided from the swimming pool or spa may flow through the interior 303 of the SCG 100 in the direction shown by the arrows. The water may flow through electrode plates 304 positioned in the body 102 of the SCG 100.

The ultrasonic generator 302 may be positioned inside the body 102 of the SCG 100 at a location where other electronics such as a controller 202 (as described in FIG. 2), logic, and a human-machine interface (HMI) are also positioned. For example, the ultrasonic generator 302 may be positioned above the electrode plates 304. The ultrasonic generator 302 may be coupled to the body 102 of the SCG 100. For example, the ultrasonic generator 302 may be positioned above the electrode plates 304 via welding, bolting, high-temperature epoxy application, clamping, and/or other similar fixation methods. The ultrasonic generator 302 may produce one or more high-frequency electrical signals that may be converted into one or more sound waves in a solution (e.g., water). In some instances, an ultrasonic generator 302 may power the one or more ultrasonic transducers 306.

In some instances, the ultrasonic frequency of the energy provided by the ultrasonic generator 302 may be imparted with a value from about 10 kHz to about 400 kHz. For example, the ultrasonic frequency may be imparted with a frequency value of no more than about 50 kHz, or no more than about 100 kHz, or no more than about 150 kHz, or no more than about 200 kHz, or no more than about 250 kHz, or no more than about 300 kHz, or no more than about 350 kHz.

In some instances, the ultrasonic frequency may be imparted with a value from 10 kHz to 400 kHz. For example, the ultrasonic frequency may be imparted with a value of no more than 50 kHz, or no more than 100 kHz, or no more than 150 kHz, or no more than 200 kHz, or no more than 250 kHz, or no more than 300 kHz, or no more than 350 kHz.

The electrode plates 304 may also be positioned inside the body 102 of the SCG 100. The electrode plates 304 may act as an electrically charged surface that uses electrolysis to split salt molecules and generate chlorine gas in salt water. The chlorine gas produced by the electrode plates 304 may help sanitize the swimming pool or spa water by creating hypochlorous acid and hypochlorite ions when mixed with the water.

The ultrasonic generator 302 may be placed in electronic communication with the one or more ultrasonic transducers 306 through a wired connection 308. In certain instances, the ultrasonic generator 302 may transmit energy to the one or more ultrasonic transducers 306 via the wired connection 308 such that the energy is converted into one or more sound waves in a cleaning solution (e.g., water), as described above. In some instances, an ultrasonic generator 302 may provide power to the one or more ultrasonic transducers 306.

The one or more ultrasonic transducers 306 may each be provided in a substantially cylindrical shape. The one or more ultrasonic transducers 306 may be designed to generate high-frequency sound waves that create tiny bubbles in the swimming pool or spa water, causing cavitation which helps to break down scale that has accumulated in the SCG 100 (e.g., on the electrode plates 304). In FIG. 3A, the SCG 100 is only provided with a single ultrasonic transducer 306. The single ultrasonic transducer 306 may be positioned near a bottom side 307 of the electrode plates 304. That is, the ultrasonic transducer 306 may be positioned adjacent to the electrode plates 304. In some instances, the ultrasonic transducer 306 may extend at least partially through an aperture or bore (not shown) provided in the body 102 of the SCG 100. More particularly, a lower portion 305 of the ultrasonic transducer 306 may extend outwardly and away from the body 102, while an upper portion 309 (see FIG. 3B) of the ultrasonic transducer 306 may be arranged within the interior 303 of the SCG 100.

The number and position of the ultrasonic transducers 306 provided in the SCG 100 may impact the efficacy of the descaling process. For example, if scale frequently accumulates at or near the bottom side 307 of the electrode plates 304, positioning the one or more ultrasonic transducers 306 at or near the bottom side 307 of the electrode plates 304 may help facilitate efficient removal of the scale accumulation and prevent scale formation at that location.

Referring now to FIG. 3B, while the components of the ultrasonic device 301 are the same as those described with reference to FIG. 3A, a single ultrasonic transducer 306 may be positioned at an alternative location within the SCG 100 as compared to the ultrasonic device of FIG. 3A. While the ultrasonic transducer shown in FIG. 3A is depicted near the bottom side 307 of the electrode plates 304, in FIG. 3B, the SCG 100 includes a single ultrasonic transducer 306 which may be positioned at, near, or adjacent to a side portion of the electrode plates 304. That is, the ultrasonic transducer 306 may be placed at a side 307B of the electrode plates 304.

The number and position of the ultrasonic transducer 306 provided in the SCG 100 may impact the efficacy of the descaling process. For example, if scale frequently accumulates at or near the side 307B of the electrode plates 304, positioning the ultrasonic transducer 306 on the side 307B of the electrode plates 304 may help facilitate efficient removal of the scale accumulation and prevent scale formation at that location. In this instance, the ultrasonic generator 302 may be connected to the ultrasonic transducer 306 through the wired connection 308.

Referring now to FIG. 3C, while the components of the ultrasonic device 301 are the same as those described with reference to FIG. 3B, two ultrasonic transducers 306 are provided and positioned at various locations on the body 102 of the SCG 100 as compared to the ultrasonic device 301 of FIG. 3B. While there is only one ultrasonic transducer 306 positioned at, near, or adjacent to the electrode plates 304 in FIG. 3B, in FIG. 3C, the SCG 100 includes a first ultrasonic transducer 306A and a second ultrasonic transducer 306B positioned at, near, or adjacent to the side 307B of the electrode plates 304. Additionally, the ultrasonic generator 302 may be connected with the first ultrasonic transducer 306A and the second ultrasonic transducer 306B through a wired connection 308.

The number and position of the ultrasonic transducers 306 provided in the SCG 100 may impact the efficacy of the descaling process. For example, if scale frequently accumulates at or near the side 307B of the electrode plates 304, positioning the first and second ultrasonic transducers 306A, 306B on the side 307B of the electrode plates 304 may facilitate efficient removal of the scale accumulation and prevent scale formation at that location. Additionally, providing more than one ultrasonic transducer 306 may increase the number of vibrations emitted by the ultrasonic device 301, thus increasing the scale removal capacity and the capacity to prevent scale formation of the ultrasonic device 301.

Referring now to FIG. 3D, while the components of the ultrasonic device 301 are the same as those described with reference to FIG. 3C, the first and second ultrasonic transducers 306A, 306B may be provided and positioned at different locations in the body 102 of the SCG 100, as compared to the ultrasonic device 301 of FIG. 3C. While the first and second ultrasonic transducers 306A, 306B may be positioned at, near, or adjacent to the side 307B of the electrode plates 304 in FIG. 3C, in FIG. 3D, the SCG 100 includes the first and second ultrasonic transducers 306A, 306B positioned at, near, or adjacent to an opposite side 307C of the electrode plates 304. Additionally, the ultrasonic generator 302 may be in electronic communication with the first and second ultrasonic transducers 306A, 306B through a wired connection 308.

The number and placement of the first and second ultrasonic transducers 306A, 306B in the SCG 100 may have an impact on the efficacy of the descaling process. For example, if scale frequently accumulates at, near, or adjacent to the side 307C of the electrode plates 304, positioning the first and second ultrasonic transducers 306A, 306B on the side 307C of the electrode plates 304 may help facilitate efficient removal of the scale accumulation and prevent scale formation at that location. Additionally, providing more than one ultrasonic transducer 306 may increase the number of vibrations emitted by the ultrasonic device 301, thus increasing the scale removal capacity and the capacity to prevent scale formation of the ultrasonic device 301.

Referring now to FIG. 3E, while the components of the ultrasonic device 301 are the same as those described with reference to FIGS. 3C and 3D, the ultrasonic generator 302 is not integrated into the body 102 of the SCG 100 as compared to the ultrasonic device 301 of FIGS. 3C and 3D. Instead, the ultrasonic generator 302 is positioned outside of the body 102 of the SCG 100.

The first and second ultrasonic transducers 306A, 306B are positioned similarly to the first and second ultrasonic transducers 306A, 306B in FIG. 3C. Additionally, the ultrasonic generator 302 may be connected to the first and second ultrasonic transducers 306A, 306B through the wired connection 308. When fully assembled, the SCG 100 may receive the wired connection 308 through bores or apertures (not shown) extending through the body 102 of the SCG 100.

Referring now to FIG. 3F, while the components of the ultrasonic device 301 may be the same as those described with reference to FIG. 3E, the first and second ultrasonic transducers 306A, 306B may be positioned proximate or adjacent to opposite sides of the electrode plates 304. Furthermore, similar to the ultrasonic generator 302 in FIG. 3E, the ultrasonic generator 302 is positioned outside of the body 102 of the SCG 100.

As shown in FIG. 3F, the first ultrasonic transducer 306A may be proximate or adjacent to the side 307B of the electrode plates 304, and the second ultrasonic transducer 306B may be proximate or adjacent to the side 307C of the electrode plates 304. The ultrasonic generator 302 may be connected to the first and second ultrasonic transducers 306A, 306B through the wired connection 308.

The number and position of the first and second ultrasonic transducers 306A, 306B in the SCG 100 may impact the efficacy of the descaling process. For example, if scale frequently accumulates at or near the side 307B and the side 307C of the electrode plates 304, positioning the first and second ultrasonic transducers 306A, 306B proximate or adjacent to the side 307B and the side 307C of the electrode plates 304 may help facilitate efficient removal of the scale accumulation and prevent scale formation at these locations. Additionally, providing more than one ultrasonic transducer 306 may increase the number of vibrations emitted by the ultrasonic device 301, thus increasing the scale removal capacity and the capacity to prevent scale formation of the ultrasonic device 301.

Referring now to FIG. 3G, while the components of the ultrasonic device 301 may be the same as those described with reference to FIG. 3F, the first and second ultrasonic transducers 306A, 306B may be positioned proximate to the bottom side 307 of the electrode plates 304. Similar to the ultrasonic generator 302 described with reference to FIGS. 3E and 3F, the ultrasonic generator 302 of FIG. 3G may be positioned outside of the body 102 of the SCG 100. The ultrasonic generator 302 may be connected to the first and second ultrasonic transducers 306A, 306B through the wired connection 308.

The number and position of the first and second ultrasonic transducers 306A, 306B in the SCG 100 may impact the efficacy of the descaling process. For example, if scale frequently accumulates at or near the bottom side 307 of the electrode plates 304, positioning the first and second ultrasonic transducers 306A, 306B on the bottom side 307 of the electrode plates 304 may help facilitate efficient removal of the scale accumulation and prevent scale formation at this location. Additionally, providing more than one ultrasonic transducer 306 may increase the number of vibrations emitted by the ultrasonic device 301, thus increasing the scale removal capacity and the capacity to prevent scale formation of the ultrasonic device 301.

Referring now to FIG. 3H, while the components of the ultrasonic device 301 may be the same as those described with reference to FIG. 3G, the first and second ultrasonic transducers 306A, 306B may be positioned proximate or adjacent to a top side 307D of the electrode plates 304. In addition, the first and second ultrasonic transducers 306A, 306B may at least partially extend into the body 102 of the SCG 100 and partially outside of the body 102. Similar to the ultrasonic generator 302 described with reference to FIGS. 3E-3G, the ultrasonic generator 302 of FIG. 3H may be positioned outside of the body 102 of the SCG 100. The ultrasonic generator 302 may be connected to the first and second ultrasonic transducers 306A, 306B through the wired connection 308. However, since a portion of the first and second ultrasonic transducers 306A, 306B may extend outside of the body 102, the wired connection 308 may also positioned outside of the body 102 of the SCG 100.

The number and position of the first and second ultrasonic transducers 306A, 306B in the SCG 100 may impact the efficacy of the descaling process. For example, if scale frequently accumulates at or near the top side 307D of the electrode plates 304, positioning the first and second ultrasonic transducers 306A, 306B proximate or adjacent to the top side 307D of the electrode plates 304 may help facilitate efficient removal of the scale accumulation and prevent scale formation at this location. Additionally, providing more than one ultrasonic transducer 306 may increase the number of vibrations emitted by the ultrasonic device 301, thus increasing the scale removal capacity and the capacity to prevent scale formation of the ultrasonic device 301.

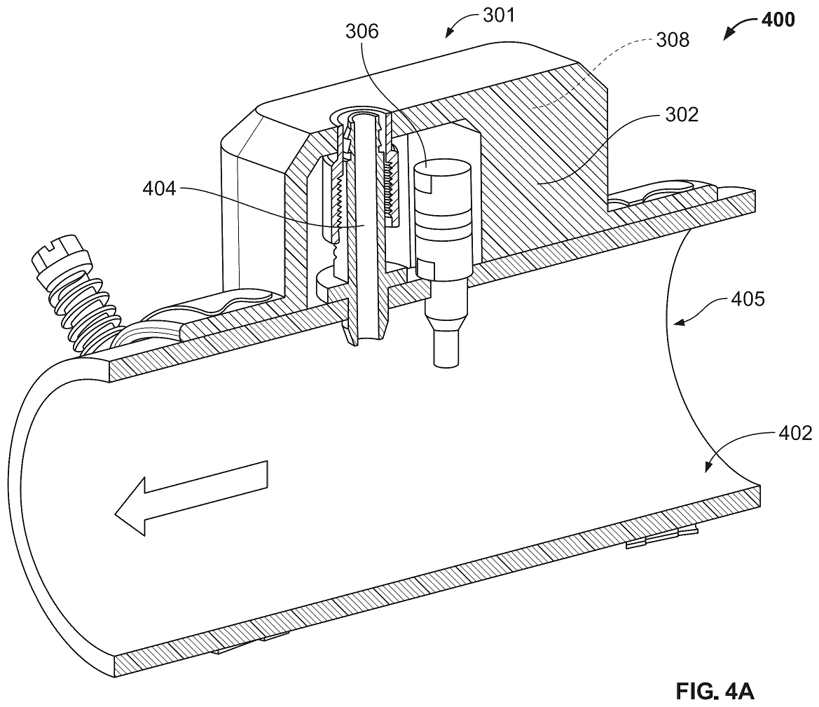

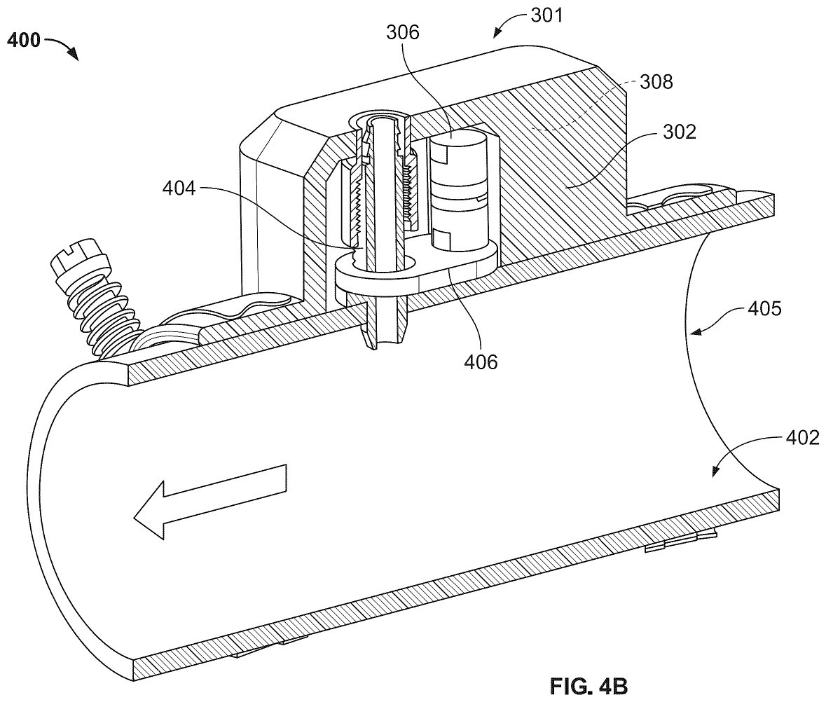

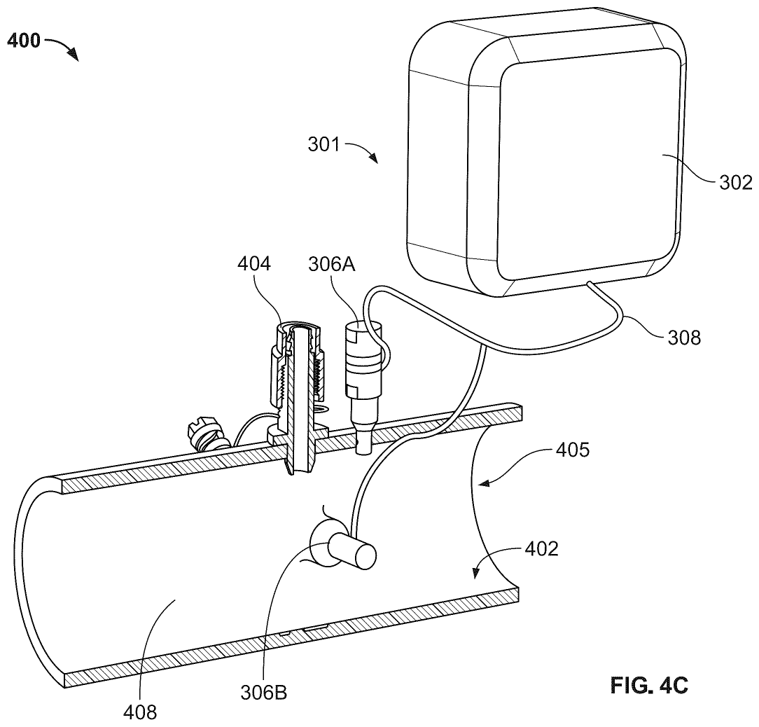

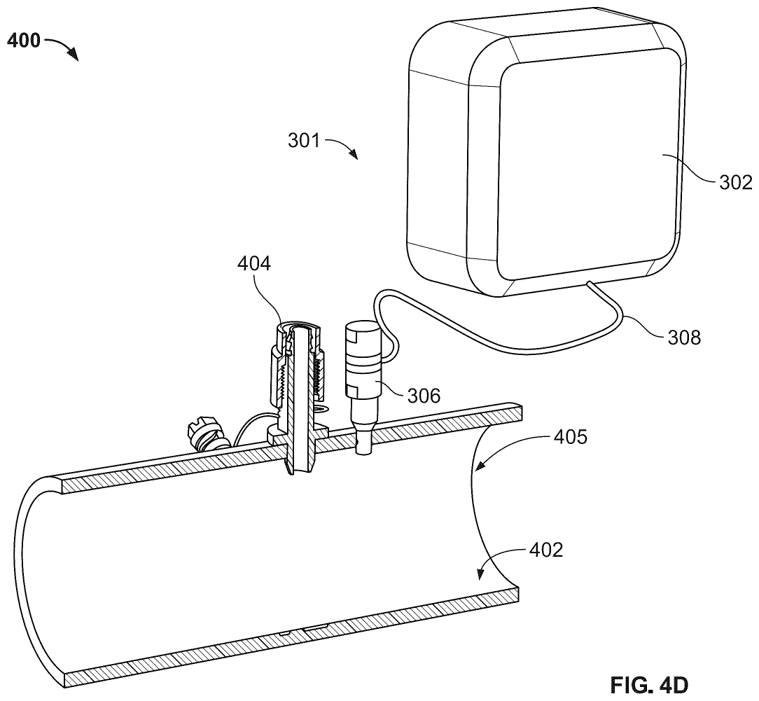

Together, FIGS. 4A-4D illustrate various implementations of a water chemistry management system including an ultrasonic device designed to remove and/or help prevent scale accumulation in a water chemistry management system 400. As will be further described herein, the ultrasonic device may be designed to provide ultrasonic energy to components of the water chemistry management system 400 that are likely to accumulate scale and/or to provide ultrasonic energy to the water surrounding such components. The application of this ultrasonic energy may help remove and/or prevent scale accumulation in the water chemistry management system 400. The various implementations of the water chemistry management system 400 may differ from each other based on the placement of the components of the ultrasonic device (e.g., an ultrasonic generator, one or more ultrasonic transducers) and, in turn, whether the ultrasonic device is primarily intended to provide the ultrasonic energy directly to the components of the water chemistry management system 400 or the water surrounding the components of the water chemistry management system 400. In addition, the water chemistry management system 400 may be associated with a sensor designed to detect an amount of scale accumulation in the water chemistry management system 400. The water chemistry management system 400 may also be associated with the controller 202 described with reference to FIG. 2.

Referring now to FIG. 4A, a cross-sectional view of an example water chemistry management system 400 is provided. The water chemistry management system 400 may be designed to help maintain various water chemistry parameters of the water of a pool or spa (e.g., a pH level, an ORP value, a chlorine concentration, etc.). The water chemistry management system 400 may be provided in the form of a flow cell 402 that is in fluid communication with an injection port 404. During use, an interior of the flow cell 402 and/or the injection port 404 may accumulate scale and/or be susceptible to scale formation. Thus, the water chemistry management system 400 may also include the ultrasonic device 301 discussed with reference to FIGS. 3A-3H. In turn, the ultrasonic generator 302, the one or more ultrasonic transducers 306, and the wired connection 308 may also be provided with the water chemistry management system 400. The water chemistry management system 400 also comprises other components that are not shown and explained here.

The flow cell 402 may be provided as a substantially cylindrical pipe or conduit designed to be in fluid communication with the swimming pool or spa, although the flow cell 402 may also be provided in other shapes and forms. The flow cell 402 may allow for water circulation to and from the swimming pool or spa and may be associated with a pool pump. The injection port 404 may be provided in the form of a substantially hollow cylinder designed to provide a chemical agent to the flow cell 402 and the water of the swimming pool or spa. The injection port 404 may also be provided in other shapes and forms. In some instances, the injection port 404 may be provided as a plastic fitting coupled to and partially extending into the flow cell 402. One end of the injection port 404 may be open (e.g., the portion extending into the flow cell 402) and another end of the injection port 404 may be coupled to a chemical feed line (not shown).

The chemical feed line may be designed to place the injection port 404 into fluid communication with a source of a chemical agent. More particularly, the chemical feed line may be in fluid communication with the source of the chemical agent, and the chemical agent may be configured to adjust the various water chemistry parameters of the water of the pool or spa. For example, the chemical feed line may be coupled to a vessel or a tank that is designed to retain the chemical agent (e.g., a chlorine-containing compound). In some instances, a pump may provide the chemical agent from the tank and facilitate injection of the chemical agent into the flow cell 402.

Referring again to FIG. 4A, in some instances, the ultrasonic generator 302 may be positioned such that the injection port 404 may be integrated into and/or positioned proximate or adjacent to the ultrasonic generator 302. Alternatively, the ultrasonic generator 302 may be provided within a body 405 of the water chemistry management system 400. The ultrasonic generator 302 may be coupled to the water chemistry management system 400 using nuts and bolts, welding, clamping, or other similar fixation assemblies. Similar to the ultrasonic generator 302 described with reference to FIGS. 3A-3H, the ultrasonic generator 302 may produce one or more high-frequency electrical signals that may be converted into one or more sound waves in water by one or more transducers. More particularly, the ultrasonic generator 302 may power the one or more ultrasonic transducers 306 that are provided with the water chemistry management system 400.

In FIG. 4A, the water chemistry management system 400 includes a single ultrasonic transducer 306, although additional ultrasonic transducers 306 may also be provided. The ultrasonic transducer 306 may be provided in a substantially cylindrical shape and may be positioned proximate or adjacent to the injection port 404. The ultrasonic transducer 306 may be coupled to the body 405 and extend at least partially into the flow cell 402, although the ultrasonic transducer 306 may be otherwise positioned and arranged in the water chemistry management system 400. The ultrasonic transducer 306 may be in electrical communication with the ultrasonic generator 302 via the wired connection 308. The ultrasonic transducer 306 may be designed to generate high-frequency sound waves that create small bubbles in water, causing cavitation which helps to break down any scale that has accumulated within the flow cell 402 and/or on the injection port 404. In some instances, the cavitation process may also help prevent the accumulation of scale within the flow cell 402 and/or on the injection port 404.

The number and placement of the ultrasonic transducers 306 in the water chemistry management system 400 may impact the efficacy of the descaling process. For example, if the scale frequently accumulates at or near the injection port 404 and inside the flow cell 402, positioning the ultrasonic transducer 306 near or adjacent to the injection port 404 and also extending at least a portion of the ultrasonic transducer 306 into the flow cell 402 may help facilitate efficient removal of the scale accumulation and prevent scale formation at those locations.

Referring now to FIG. 4B, while the components of the ultrasonic device 301 are the same as those described with reference to FIG. 4A, the ultrasonic transducer 306 of FIG. 4B may not extend into the flow cell 402, as compared to the ultrasonic transducer 306 of FIG. 4A. In FIG. 4B, the water chemistry management system 400 only includes a single ultrasonic transducer 306, although additional ultrasonic transducers 306 may also be provided. The ultrasonic transducer 306 may be positioned at and/or coupled to a base plate 406 of the injection port 404, although the ultrasonic transducer 306 may otherwise be positioned proximate or adjacent to the injection port 404. The ultrasonic generator 302 and the ultrasonic transducer 306 are connected via the wired connection 308.

The position and placement of the ultrasonic transducers 306 in the water chemistry management system 400 may impact the efficacy of the descaling process. For example, if scale frequently accumulates at or near the base plate 406 and/or the injection port 404, positioning one or more ultrasonic transducers 306 at or near the base plate 406 and/or the injection port 404 may help facilitate efficient removal of the scale accumulation and prevent scale formation at that location.

Referring to FIG. 4C, while the components of the ultrasonic device 301 are the same as those described with reference to FIGS. 4A and 4B, the ultrasonic device 301 of FIG. 4C may include the first ultrasonic transducer 306A and the second ultrasonic transducer 306B. Further, the ultrasonic generator 302 may not be coupled to the flow cell 402. The first ultrasonic transducer 306A may be positioned at, near, or adjacent to the injection port 404 and extend at least partially into the flow cell 402. The ultrasonic transducer 306B may be coupled to an interior wall 408 of the flow cell 402 and extend outwardly from the interior wall 408. The ultrasonic generator 302, and the ultrasonic transducer 306 are connected through the wired connection 308.

The number and position of the first and second ultrasonic transducers 306A, 306B in the water chemistry management system 400 may impact the efficacy of the descaling process. For example, if scale frequently accumulates at, near, or adjacent to the injection port 404 in the flow cell 402 and/or on the interior wall 408 of the flow cell 402, positioning the first and second ultrasonic transducers 306A, 306B at, proximate, or adjacent to the injection port 404 and within the flow cell 402 may help facilitate efficient removal of the scale accumulation and prevent scale formation at these locations.

Similar to the swimming pool or spa devices depicted in FIGS. 3E-3H, in this example, the ultrasonic generator 302 may be placed externally, outside of, or at a remote location relative to the water chemistry management system 400. In this instance, the ultrasonic generator 302 may be connected with both the first and second ultrasonic transducers 306A, 306B through the wired connection 308.

Referring to FIG. 4D, while the components of the ultrasonic device 301 are the same as those described with reference to FIGS. 4A-4C, the ultrasonic device 301 of FIG. 4D may include a single ultrasonic transducer 306. Furthermore, the ultrasonic generator 302 may not be coupled to the flow cell 402 (similar to the device of FIG. 4C). The ultrasonic transducer 306 may be positioned at, near, or adjacent to the injection port 404. In addition, the ultrasonic transducer 306 may extend at least partially into the flow cell 402. The ultrasonic generator 302, and the ultrasonic transducer 306 may be placed in electronic communication via the wired connection 308.

The number and position of the ultrasonic transducers 306 in the water chemistry management system 400 may impact the efficacy of the descaling process. For example, if scale accumulates at, proximate, or adjacent to the injection port 404, positioning the one or more ultrasonic transducers 306 at, proximate, or adjacent to the injection port 404 may help facilitate efficient removal of the scale accumulation and prevent scale formation at that location.

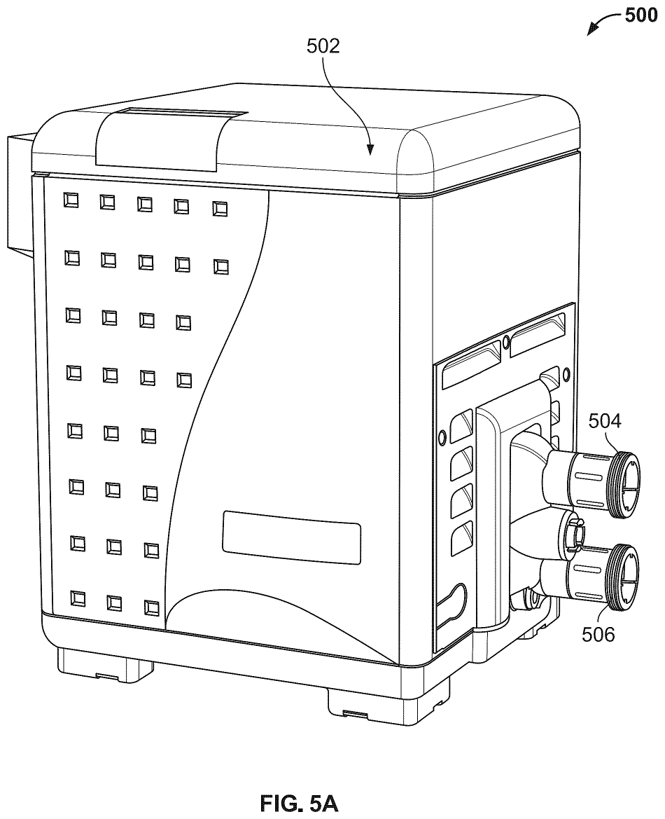

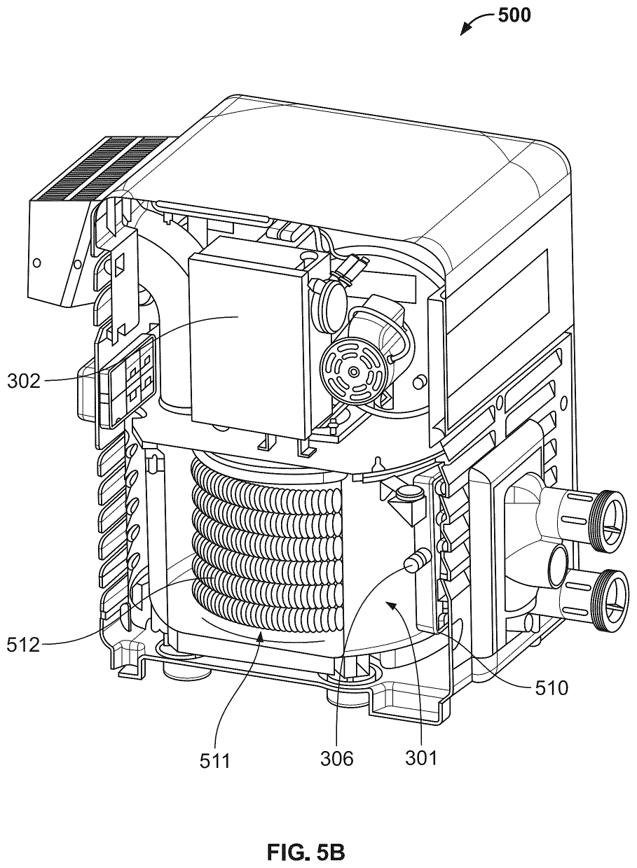

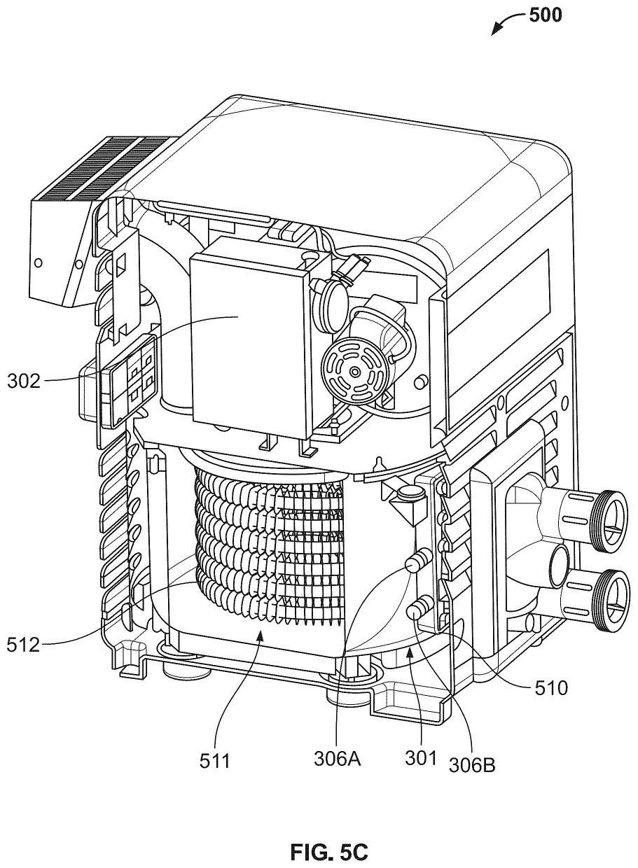

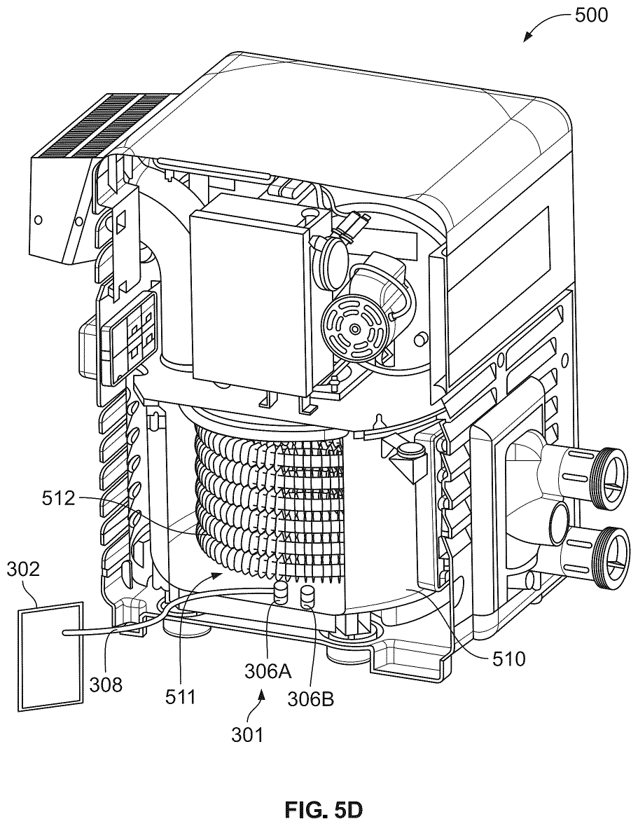

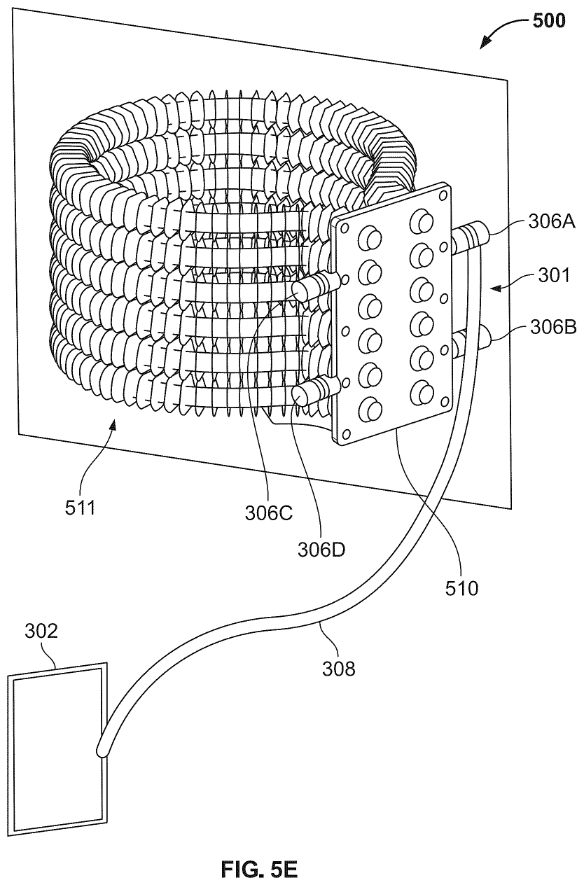

Together, FIGS. 5A-5E illustrate various implementations of an ultrasonic device, each implementation designed to remove and/or help prevent scale accumulation in a gas-fired heater 500. As will be further described herein, the ultrasonic device may be designed to provide ultrasonic energy to components of the gas-fired heater 500 that are likely to accumulate scale and/or to the water surrounding such components. The application of this ultrasonic energy may remove and/or help prevent scale accumulation in the gas-fired heater 500. The various implementations may differ from each other based on the placement of the components (e.g., an ultrasonic generator, one or more ultrasonic transducers) of the ultrasonic device and, in turn, whether the ultrasonic device is primarily intended to provide the ultrasonic energy directly to the components of the gas-fired heater 500 or the water surrounding the components of the gas-fired heater 500. In addition, the gas-fired heater 500 may be associated with a sensor that is designed to detect an amount of scale accumulation in the gas-fired heater 500 and/or within particular components of the gas-fired heater 500. The gas-fired heater 500 may also be associated with the controller 202 described with reference to FIG. 2

Referring to FIG. 5A, an example gas-fired heater 500 is shown. The gas-fired heater 500 may be used for heating the water of a swimming pool or spa. The gas-fired heater 500 may be provided in the form of a housing 502 in fluid communication with a first inflow port 504 and a first outflow port 506 designed to accommodate incoming and outgoing water, respectively, through the gas-fired heater 500. The housing 502 may be provided substantially in the shape of a rectangular prism, although other shapes and forms may be used for the housing 502. The first inflow port 504 and the first outflow port 506 may be designed to place the gas-fired heater 500 in fluid communication with the pool or spa.

Plumbing (not shown) may be provided to facilitate fluid communication between the various components of the gas-fired heater 500 and the pool or spa. The gas-fired heater 500 may be equipped with a digital operating control system (not shown) that enables the user to pre-set the desired pool or spa water temperatures. The control system may enable the user to select between pool or spa heating and may include a digital display that indicates the water temperature and heater set point.

Referring to FIG. 5B, the gas-fired heater 500 may include the ultrasonic device 301 provided in the form of the ultrasonic generator 302, the one or more ultrasonic transducers 306, and the wired connection 308, similar to the ultrasonic device 301 described with reference to FIGS. 3A-4D. The gas-fired heater 500 may also include an end plate 510 that is associated with the first inflow port 504 and first outflow port 506 (see FIG. 5A) and a heat exchanger 511 including a plurality of coils 512.

The end plate 510 may be provided in the form of a substantially flat, rectangular prism, although the end plate 510 may also be provided in other shapes and forms. The end plate 510 may be positioned adjacent to the plurality of coils 512 in the housing 502. The end plate 510 may help seal at least one end of the heat exchanger 511, thereby helping to create a closed system for the transfer of heat to the water of the pool or spa. In certain instances, the end plate 510 may also provide structural support for the heat exchanger 511 and may help maintain the proper flow of fluids through the gas-fired heater 500.

The plurality of coils 512 of the heat exchanger 511 may be arranged in a substantially spring-like configuration (although the plurality of coils may be alternatively arranged), and the plurality of coils 512 may be positioned in the housing 502 of the gas-fired heater 500. The plurality of coils 512 may be substantially hollow such that water may be received into and flow through the plurality of coils 512. The plurality of coils 512 may also be in fluid communication with the first inflow port 504 and the first outflow port 506. The plurality of coils 512 may help facilitate the transfer of heat from gas that is burned in the gas-fired heater 500 to the water of the pool or spa, thereby heating the water as the water flows through the housing 502 of the gas-fired heater 500.

Referring again to FIG. 5B, the gas-fired heater 500 includes a single ultrasonic transducer 306 coupled to the end plate 510 of the heat exchanger 511, although additional ultrasonic transducers 306 may also be provided. That is, the ultrasonic transducer 306 may be positioned proximate or adjacent to the heat exchanger 511. For example, the ultrasonic generator 302 may be positioned above the heat exchanger 511. The ultrasonic generator 302 may be positioned inside the housing 502 of the gas-fired heater 500. The ultrasonic generator 302 may be in electronic communication with the ultrasonic transducer 306 through the wired connection 308 (not shown).

The number and position of the ultrasonic transducers 306 in the gas-fired heater 500 may impact the efficacy of the descaling process. For example, if the scale frequently accumulates at or near the end plate 510 and/or within the plurality of coils 512, coupling the ultrasonic transducer 306 to the end plate 510 may help facilitate efficient removal of the scale accumulation and prevent scale formation at that location.

Referring to FIG. 5C, while the components of the ultrasonic device 301 are the same as those described with reference to FIG. 5B, the first ultrasonic transducer 306A and the second ultrasonic transducer 306B are coupled to the end plate 510, as compared to the ultrasonic device 301 of FIG. 5B. The first and second ultrasonic transducers 306A, 306B may be positioned proximate or adjacent to one another on the end plate 510. Similar to the ultrasonic device 301 in FIG. 5B, the ultrasonic generator 302 may be positioned inside the gas-fired heater 500 and above the heat exchanger 511. In addition, the ultrasonic generator 302 may be in electronic communication with the ultrasonic transducer 306 through the wired connection 308 (not shown).

The number and position of the first and second ultrasonic transducers 306A, 306B in the gas-fired heater 500 may impact the efficacy of the descaling process. For example, if scale frequently accumulates at or near the end plate 510 and/or within the plurality of coils 512, positioning the first and second ultrasonic transducers 306A, 306B on the end plate 510 may help facilitate efficient removal of the scale accumulation and prevent scale formation at those locations. Additionally, providing the first and second ultrasonic transducers 306A, 306B may increase the number of vibrations emitted by the ultrasonic device 301, thus increasing the scale removal capacity and the capacity to prevent scale formation of the ultrasonic device 301.

Referring to FIG. 5D, while the components of the ultrasonic device 301 are the same as those described with reference to FIGS. 5B and 5C, the first ultrasonic transducer 306A and the second ultrasonic transducer 306B may be provided in an alternative location in the housing 502, as compared to the ultrasonic device 301 of FIGS. 5B and 5C. More particularly, the first and second ultrasonic transducers 306A, 306B may be positioned adjacent to the plurality of coils 512 without being coupled to the end plate 510.

Additionally, in FIG. 5D, the ultrasonic generator 302 may be positioned outside of the housing 502 of the gas-fired heater 500. Similar to the ultrasonic device 301 in FIGS. 5B and 5C, the ultrasonic generator 302 may be in electronic communication with the first and second ultrasonic transducers 306A, 306B via the wired connection 308.

The number and position of the first and second ultrasonic transducers 306A, 306B in the gas-fired heater 500 may impact the efficacy of the descaling process. For example, if scale frequently accumulates at, near, or adjacent to the plurality of coils 512, positioning the first and second ultrasonic transducers 306A, 306B at, near, or adjacent to the plurality of coils 512 may help facilitate efficient removal of the scale accumulation and prevent scale formation within the plurality of coils 512. Additionally, providing the first and second ultrasonic transducers 306A, 306B may increase the number of vibrations emitted by the ultrasonic device 301, thus increasing the scale removal capacity and the capacity to prevent scale formation of the ultrasonic device 301.

Referring to FIG. 5E, the components of the ultrasonic device 301 may be the same as those described with reference to FIGS. 5B-5D. However, in the case of FIG. 5E, four ultrasonic transducers may be coupled to the end plate 510 and positioned near the plurality of coils 512. Additionally, the ultrasonic generator 302 may be located outside of the housing 502 (not shown) of the gas-fired heater 500, similar to the instance described with reference to FIG. 5D.

The four ultrasonic transducers may include the first ultrasonic transducer 306A, the second ultrasonic transducer 306B, a third ultrasonic transducer 306C, and a fourth ultrasonic transducer 306D. The first, second, third, and fourth ultrasonic transducers 306A, 306B, 306C, 306D may be positioned on the end plate 510 and also be proximate or adjacent to the plurality of coils 512. The first and third ultrasonic transducers 306A, 306C may be positioned opposite of each other on sides of the end plate 510, while the second and fourth ultrasonic transducers 306B, 306D may be positioned on opposite sides of the end plate 510. The first, second, third, and fourth ultrasonic transducers 306A, 306B, 306C, 306D may be alternatively arranged on the end plate 510. The ultrasonic generator 302 may be in electronic communication with the first, second, third, and fourth ultrasonic transducers 306A, 306B, 306C, 306D positioned inside the gas-fired heater 500 via the wired connection 308.

The number and position of the first, second, third, and fourth ultrasonic transducers 306A, 306B, 306C, 306D in the gas-fired heater 500 may impact the efficacy of the descaling process. For example, if the scale frequently accumulates at or near the end plate 510 and/or in the plurality of coils 512, positioning the first, second, third, and fourth ultrasonic transducers 306A, 306B, 306C, 306D on the end plate 510 and proximate or adjacent to the plurality of heating coils 511 may help facilitate efficient removal of the scale accumulation and prevent scale formation at those locations. Additionally, providing the first, second, third, and fourth ultrasonic transducers 306A, 306B, 306C, 306D may increase the number of vibrations emitted by the ultrasonic device 301, thus increasing the scale removal capacity and the capacity to prevent scale formation of the ultrasonic device 301.

In FIGS. 3A-3H, 4A-4D, and 5A-5D, the wired connection 308 corresponds to an electrical cable. Although FIGS. 3A-3H, 4A-4D, and 5A-5D show the ultrasonic generator 302 in connection with the one or more ultrasonic transducers 306 through a wired connection 308, it should be understood by a person skilled in the art that the ultrasonic generator 302 may also be connected wirelessly with the one or more ultrasonic transducers 306 through inductive coupling instead of via the wired connection 308. In addition, the wired connection 308 may extend to each individual ultrasonic transducer 306 provided in the ultrasonic device 301. In some instances, additional connections between the ultrasonic generator 302 and the one or more ultrasonic transducers 306 may also be provided.

Although FIGS. 3A-3H, 4A-4D, and 5A-5D show different example locations for positioning the ultrasonic transducer 306 in the swimming pool or spa devices 100, 400, 500, other locations for positioning the one or more ultrasonic transducers 306 in the swimming pool or spa devices 100, 400, 500 are within the scope of the present disclosure. Further, the number of ultrasonic transducers 306 in the swimming pool or spa devices 100, 400, 500 is not limited to the number of such transducers described herein. More particularly, the swimming pool or spa devices 100, 400, 500 may include fewer or additional ultrasonic transducers than described herein.

Although FIGS. 3A-3H, 4A-4D, and 5A-5D show a limited number of components of the swimming pool or spa device 100, 400, 500, it should be understood by a person skilled in the art that such swimming pool or spa devices 100, 400, 500 also include other components which may not be shown herein.

In certain instances, the ultrasonic generator 302 and/or the ultrasonic transducer 306 may be affixed to the swimming pool or spa devices 100, 400, 500 via welding, bolting, clamping, high-temperature epoxy application, or other fixation methods not specifically referenced herein.

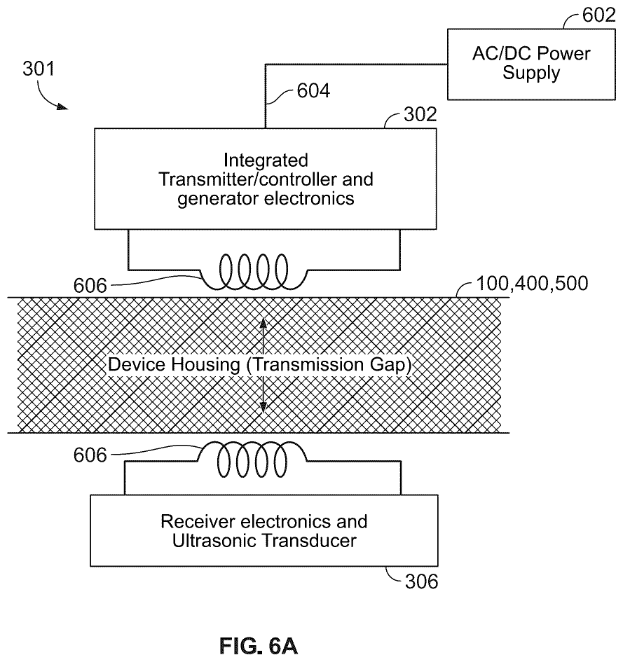

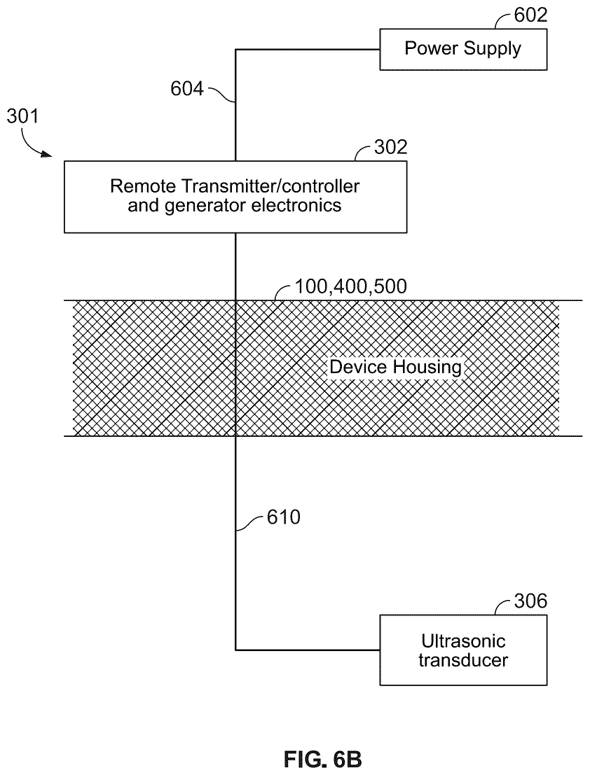

Referring now to FIG. 6A, connections between a swimming pool or spa device 100, 400, 500, the ultrasonic generator 302, and the one or more ultrasonic transducers 306 are provided. In this example, an alternating current (AC) and/or a direct current (DC) power supply 602 may be in electronic communication with the ultrasonic generator 302 through a wired connection 604. In some instances, the wired connection 604 corresponds to an electrical cable.

In this example, the ultrasonic generator 302 may be integrated inside the swimming pool or spa device 100, 400, 500 and may be positioned alongside other electronics such as a transmitter or controller. In alternative instances, the ultrasonic generator 302 may be provided outside of the swimming pool or spa device 100, 400, 500. Further, the ultrasonic generator 302 may be inductively coupled with the swimming pool or spa device 100, 400, 500 (and the one or more ultrasonic transducers 306) through one or more magnetic coils 606. As such, the ultrasonic generator 302 may wirelessly communicate or transfer power or ultrasonic signals to the one or more ultrasonic transducers 306 via the one or more magnetic coils 606. In some instances, the power or ultrasonic signals may be communicated from the ultrasonic generator 302 to the one or more ultrasonic transducers 306 through a housing of the swimming pool or spa device 100, 400, 500.

The swimming pool or spa device 100, 400, 500 may also be provided with the one or more ultrasonic transducers 306 that are inductively connected to the swimming pool or spa device 100, 400, 500. In this instance, the one or more ultrasonic transducers 306 may be integrated inside the swimming pool or spa device 100, 400, 500 and may be positioned alongside other electronics such as a receiver or a controller. In this example, the one or more ultrasonic transducers 306 may be positioned inside the swimming pool or spa device 100, 400, 500.

Referring now to FIG. 6B, connections between the swimming pool or spa device 100, 400, 500, the ultrasonic generator 302, and the one or more ultrasonic transducers 306 are provided. In this example, the alternating current (AC) and/or a direct current (DC) power supply 602 may be in electronic communication with the ultrasonic generator 302 through the wired connection 604. In some instances, the wired connection 604 corresponds to an electrical cable. Additionally, the ultrasonic generator 302 may be placed externally to, outside of, or in a remote location in relation to the swimming pool or spa device 100, 400, 500.

The ultrasonic generator 302 may be connected with the one or more ultrasonic transducers 306 through a wired connection 610 positioned at least partially within the swimming pool or spa device 100, 400, 500. In this example, the one or more ultrasonic transducers 306 may be positioned inside the swimming pool or spa device 100, 400, 500. Thus, the wired connection 610 may extend through a housing of the swimming pool or spa device 100, 400, 500.

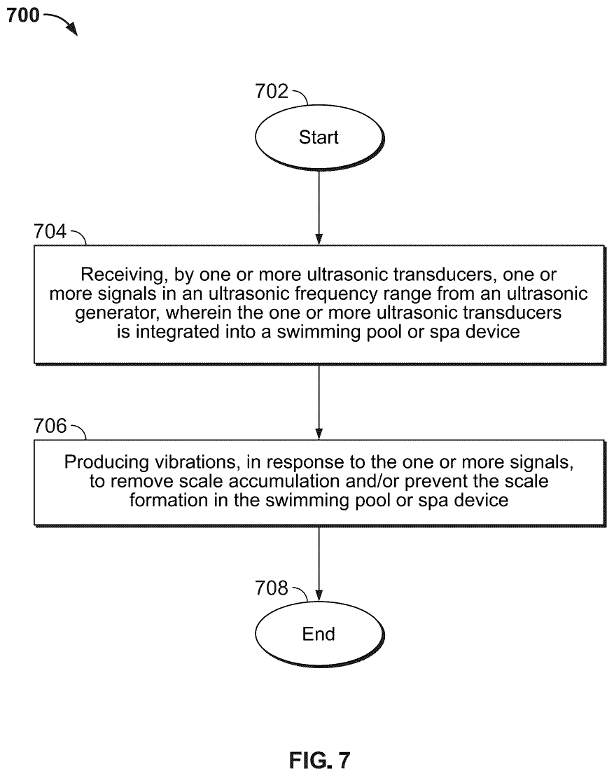

Referring now to FIG. 7, a method 700 for preventing scale formation and/or removing the scale accumulation in a swimming pool or spa device (e.g., the swimming pool or spa device 100, 400, 500 of FIGS. 1, 3A-6B) is provided. The method 700 starts at a step 702.

At a step 704, one or more ultrasonic transducers receive electrical ultrasonic signals in an ultrasonic frequency range from an ultrasonic generator. The one or more ultrasonic transducers may be integrated into a swimming pool or spa device. The ultrasonic generator may be connected with the one or more ultrasonic transducers via a wireless connection or a wired connection. For example, the ultrasonic signals may be wirelessly received by the one or more ultrasonic transducers from the ultrasonic generator. As an additional example, the ultrasonic signals from the ultrasonic generator may be received by the one or more ultrasonic transducers through the wired connection.

The electrical ultrasonic signals may be received from the ultrasonic generator by the one or more ultrasonic transducers when the ultrasonic generator and/or the swimming pool or spa device are turned on.

The ultrasonic generator may be positioned inside the swimming pool or spa device or positioned outside of a housing of the swimming pool or spa device. The ultrasonic generator may be connected to a power supply (as shown in FIGS. 6A and 6B).

In some instances, the ultrasonic frequency generated by the ultrasonic generator may be imparted with a value from about 10 kHz to about 400 kHz. For example, the ultrasonic frequency may be imparted with a value of no more than about 50 kHz, or no more than about 100 kHz, or no more than about 150 kHz, or no more than about 200 kHz, or no more than about 250 kHz, or no more than about 300 kHz, or no more than about 350 kHz. In other instances, the ultrasonic frequency may be imparted with a value from 10 kHz to 400 kHz. For example, the ultrasonic frequency may be imparted with a value of no more than 50 kHz, or no more than 100 kHz, or no more than 150 kHz, or no more than 200 kHz, or no more than 250 kHz, or no more than 300 kHz, or no more than 350 kHz.

At a step 706, in response to the electrical ultrasonic signals received by the one or more ultrasonic transducers, the one or more ultrasonic transducers may produce vibrations in the ultrasonic frequency range. These vibrations may provide energy to the swimming pool or spa device and/or cause the vibration of the swimming pool or spa device. Thus, the ultrasonic transducers may facilitate the removal of scale in the swimming pool or spa device and/or help prevent the formation of scale in the swimming pool or spa device. In another instance, the vibrations may create high-frequency pulses in the water. Further, the continuous vibration, through the use of microstreaming, may result in the prevention of any new scale formation in the swimming pool or spa device 100, 400, 500.

The method 700 ends at a step 708.

The present disclosure also encompasses the features of deploying one or more sensors in the swimming pool or spa device for determining the presence of the scale accumulation in the swimming pool or spa device. The one or more sensors of the swimming pool or spa device may be in electronic communication with a controller (e.g., the controller 202) associated with the ultrasonic generator 302. In addition, the one or more sensors may be designed to transmit information associated with the presence of scale in the swimming pool or spa device and, accordingly, may be used by the controller in a determination of whether to turn the ultrasonic device on or off. For example, the controller may turn off the ultrasonic generator if no or little scale accumulation is detected by the one or more sensors. As an additional example, the controller may continue to operate the ultrasonic device if the one or more sensors detect scale accumulation in the swimming pool or spa device, or if the scale accumulation is above a predetermined threshold value.

In yet another instance, a pre-defined time interval can be set for turning on or turning off the ultrasonic generator of the swimming pool or spa device. For instance, the ultrasonic generator may be turned on for a continuous period (e.g., a continuous period of at least about two hours once a day, a continuous period of at least about three hours once a day, etc.). Such a defined time interval can be automatically set by the swimming pool or spa device. In some instances, the defined time interval may be determined by the controller and based on an accumulation of scale within the pool or spa device. For example, signals from the one or more sensors provided in the swimming pool or spa device may communicate information to the controller related to the formation of scale. The controller may then in turn direct the ultrasonic device to begin a descaling operation. Alternatively, such a defined time interval can be manually set by a user or an operator of the swimming pool or spa device.

In some instances, the ultrasonic generator may be automatically turned off when the swimming pool or spa device is turned off. In certain instances, the ultrasonic generator may be automatically turned on when the swimming pool or spa device is turned on. In yet other instances, the ultrasonic generator may be automatically turned on when the swimming pool or spa device is turned off. In other instances, the ultrasonic generator may be automatically turned off when the swimming pool or spa device is turned on.

The present disclosure provides several technical advantages over the existing approaches. For example, the present disclosure eliminates the need for mechanical, chemical, and manual removal of scale in the swimming pool or spa device, provides an automatic solution for removal the scale accumulation in a swimming pool or spa device, and automatically prevents the formation of scale deposition in the swimming pool or spa device by turning-on an ultrasonic generator and an ultrasonic transducer for a continuous pre-defined period of time.

It will be appreciated by those skilled in the art that while the invention has been described above in connection with particular instances and examples, the invention is not necessarily so limited, and that numerous other instances, examples, uses, modifications, and departures from the instances, examples, and uses are intended to be encompassed by the claims attached hereto. The entire disclosure of each patent and publication cited herein is incorporated by reference as if each such patent or publication were individually incorporated by reference herein. Various features and advantages of the invention are set forth in the following claims.

What is claimed is:

1. A pool or spa device comprising:
a housing defining an interior of the pool or spa device;
a first component of the pool or spa device that is positioned within the interior of the housing;
an ultrasonic device provided in the form of:
an ultrasonic generator designed to generate at least one signal in an ultrasonic frequency range; and
a first ultrasonic transducer in communication with the ultrasonic generator, the first ultrasonic transducer designed to produce ultrasonic vibrations in response to the at least one signal; and
a controller in communication with the ultrasonic device,
wherein the ultrasonic vibrations remove scale accumulation from the first component of the pool or spa device.

2. The pool or spa device of claim 1, wherein the ultrasonic vibrations also prevent scale formation in the pool or spa device.

3. The pool or spa device of claim 1, wherein the pool or spa device is a salt chlorine generator, a gas-fired heater, or a water chemistry management system.

4. The pool or spa device of claim 1, wherein the pool or spa device is a salt chlorine generator, and the first ultrasonic transducer is positioned proximate to an electrode plate of the salt chlorine generator.

5. The pool or spa device of claim 4, wherein the ultrasonic device includes a second ultrasonic transducer, and wherein each of the first ultrasonic transducer and the second ultrasonic transducer are positioned proximate to the electrode plate of the salt chlorine generator.

6. The pool or spa device of claim 1, wherein the ultrasonic device includes a second ultrasonic transducer.

7. The pool or spa device of claim 1, wherein the pool or spa device is provided in the form of a water chemistry management system and the first ultrasonic transducer is positioned adjacent to an injection port of the water chemistry management system.

8. The pool or spa device of claim 7, wherein the first ultrasonic transducer is coupled to a flow cell of the water chemistry management system.

9. The pool or spa device of claim 1, wherein the first component is provided in the form of an electrode cell.

10. A pool or spa device comprising:
a body designed to retain one or more components of the pool or spa device;
an ultrasonic device provided in the form of an ultrasonic generator that is in communication with a first ultrasonic transducer; and
a controller designed to activate the ultrasonic generator whereby the ultrasonic generator sends a signal to the first ultrasonic transducer during operation of the ultrasonic device,
wherein the ultrasonic device is designed to prevent scale accumulation in the pool or spa device.

11. The pool or spa device of claim 10, wherein the pool or spa device is a salt chlorine generator, a gas-fired heater, or a water chemistry management system.

12. The pool or spa device of claim 10, wherein the one or more components of the pool or spa device include a plurality of electrode plates.

13. The pool or spa device of claim 10, wherein:
the pool or spa device is provided in the form of a salt chlorine generator including a plurality of electrode plates,
the first ultrasonic transducer is positioned proximate to a first side of the plurality of electrode plates, and
a second ultrasonic transducer of the ultrasonic device is positioned on a second side of the plurality of electrode plates.

14. The pool or spa device of claim 10, wherein the first ultrasonic transducer is positioned above or below a plurality of electrode plates of a salt chlorine generator.

15. The pool or spa device of claim 10, wherein the ultrasonic generator is positioned outside of the body of the pool or spa device.

16. The pool or spa device of claim 10, wherein the first ultrasonic transducer extends at least partially into the body of the pool or spa device.

17. The pool or spa device of claim 10, wherein the ultrasonic generator and the first ultrasonic transducer are positioned within the body of the pool or spa device.

18. The pool or spa device of claim 10, wherein the pool or spa device is provided in the form of a gas-fired heater, and the first ultrasonic transducer is positioned adjacent to a plurality of coils of a heat exchanger of the gas-fired heater.

19. A method for removing and preventing scale accumulation in a pool or spa device, the method comprising:
providing an ultrasonic device provided in the form of an ultrasonic generator and an ultrasonic transducer;
generating an ultrasonic signal via the ultrasonic generator;
receiving the ultrasonic signal from the ultrasonic generator; and
producing vibrations in the ultrasonic transducer in response to the ultrasonic signal from the ultrasonic generator,
wherein the ultrasonic transducer is received in the pool or spa device.

20. The method of claim 19 further including a step of removing the scale accumulation from the pool or spa device.
